(19) United States
(12) Patent Application Publication
(10) Pub. No.: US 2007/0172000 A1
(43) Pub. Date: Jul. 26, 2007

(54) Modulation method and demodulation method achieving high-quality modulation-and-demodulation performance, and modulation apparatus, demodulation apparatus receiving apparatus using the same

(76) Inventors: Katsuaki Hamamoto, Ogaki-shi (JP); Sanshirou Shiina, Mizuho-shi (JP); Takeshi Sakamoto, Gifu-shi (JP)

Correspondence Address: MCDERMOTT WILL & EMERY LLP, 600 13TH STREET, N.W., WASHINGTON, DC, 20005-3096, US

(21) Appl. No.: 11/645,793

(22) Filed: Dec. 27, 2006

(30) Foreign Application Priority Data
Dec. 27, 2005 (JP) 2005-375607
Jan. 30, 2006 (JP) 2006-021386

(51) Int. Cl. H04L 27/00

(52) U.S. Cl. 375/324

(57) ABSTRACT

A general purpose of the present invention includes providing a high-quality transmission in a multi-level modulation. Signal points to which symbols are to be assigned are not fixed and the positions of the signal points are varied for each transmission so as to reduce the symbols assigned only to the signal points having low error resilience. The assignment of bits in each symbol and an arrangement rule for the signal points in a QAM modulation scheme are varied per transmission so as to prevent any particular symbol from constantly exhibiting the low error resilience. The error rate is reduced and the throughput is enhanced.

### BACKGROUND OF THE INVENTION

1. Field of the Invention

The present invention relates to the communication technologies, and it particularly relates to a method for modulating and demodulating the radio signals and it also particularly relates to a modulation apparatus, a demodulation apparatus and a receiving apparatus utilizing the same.

2. Description of the Related Art

In recent years, the high-speed data communication is realized by the advancement in the communication techniques. The amount of data to be transmitted has increased per unit time in the high-speed data communication, so that the error rate needs to be lowered. It is because the increase in error rate has an effect on the throughput or the capacity in a communication system. In the conventional practice, the same data are modulated and transmitted using different arrangements and, in the receiving side, the modulated signals in one of the arrangements exhibiting a desirable receiving condition are selected and demodulated so as to improve the estimation accuracy of the received signals and lower the error rate (see Reference (1) in the following Related Art List, for instance).

### RELATED ART LIST

(1) Japanese Patent Application Laid-Open No. 2005-027326.

Under these circumstances, the inventors came to recognize the following problems to be solved. That is, in the case of a multi-level modulation such as 16-QAM (Quadrature Amplitude Modulation), the distance between signal points is smaller as compared with two-level modulation such as BPSK (Binary Phase Shift Keying). Accordingly, if the demodulation is performed based on a single received signal only, the error rate in the multi-level modulation will be larger than that in the two-level modulation and the transmittable range will be shorter.

### SUMMARY OF THE INVENTION

The present invention has been made in view of the foregoing circumstances and a general purpose thereof is to provide a high-quality modulation-and-demodulation technique that does not adversely affect the error rate even in the case of using multi-level modulation.

In order to solve the above problems, a modulation apparatus according to one embodiment of the present invention comprises: an input unit which inputs symbols to be transmitted; a first modulation unit which performs an arrangement processing in a manner that the symbols inputted from the input unit are arranged to any of signal points by using a modulation scheme based on a signal constellation that contains a plurality of signal points having a plurality of kinds of amplitudes; a second modulation unit which performs an arrangement processing in a manner that the symbols inputted from the input unit are rearranged to signal points that differ from those arranged in the first modulation unit, by using the modulation scheme, wherein the signal points are contained in different quadrants from those in the signal constellation; and an output unit which outputs the symbols that have undergone the arrangement processings by the first modulation unit and the second modulation unit, respectively.

Here, the “modulation scheme based on a signal constellation that contains a plurality of signal points having a plurality of kinds of amplitudes” includes a multi-level modulation scheme that uses not only a phase modulation but also other modulations, and the “modulation” includes, for example, 16-QAM, 8A-PSK (Amplitude-Phase Shift Keying) or the like. The “quadrant” is any of four quadrants contained in a so-called constellation, which is the signal coordinates constituted by the real axis and the imaginary axis. According to this embodiment, the same symbols are assigned respectively to different signal points, so that the error probability in the positions of the signal points can be averaged in the receiving side.

The second modulation unit may assign a signal point, arranged in the first modulation unit, having a minimum amplitude with the origin of the signal constellation as a center, to a signal point lying in a quadrant symmetrical with respect to the origin wherein the signal point has a maximum amplitude. The first modulation unit may perform the arrangement processing on any of a plurality of signal points contained in the signal constellation in a manner that either an in-phase component or a quadrature component contained in a symbol inputted from the input unit is weighted, and the second modulation unit may assign the symbol to a signal point whose distance from the signal point assigned by the first modulation unit is far in a manner that the component other than that to be weighted in the first modulation unit is weighted. The first modulation unit may assign a symbol to a signal point defined according to bits indicative of a quadrant to which the symbol is to be assigned and bits indicative of placement within the quadrant, wherein the bits are contained in the symbols inputted by the input unit, and the second modulation unit may assign a symbol to a signal point defined by a rule such that bits indicative of a quadrant is those indicative of placement within the quadrant whereas bits indicative of placement of a quadrant is those indicative of the quadrant, wherein the bits are contained in the symbols inputted by the input unit. By varying the order of a plurality of bits contained in each symbol, the second modification unit may regard bits, contained in a symbol, indicative of a quadrant as those indicative of placement within the quadrant whereas it may regard bits, contained in a symbol, indicative of a placement as those indicative of a quadrant.

Here, “regard bits, contained in a symbol, indicative of a quadrant as those indicative of placement within the quadrant whereas it may regard bits, contained in a symbol, indicative of a placement as those indicative of a quadrant” includes that the bits indicative of a quadrant are treated as those indicative of placement within the quadrant, or that the bits indicative of placement within a quadrant is treated as those indicative of the quadrant, and also includes, for example, that the bits indicative of a quadrant and those indicative of placement within the quadrant are switched around. According to this embodiment, by employing a simplified processing, the same symbols can be assigned to the different signal points without the increase in circuit scale. Also, the distances between the signal points to be assigned at the first transmission and those at the second transmission are set far, so that the error resilience can be averaged.

Another embodiment of the present invention relates to a receiving apparatus. This apparatus comprises: a symbol receiver which receives a first symbol assigned to any of a plurality of signal points contained in a signal constellation, using a modulation scheme based on the signal constellation that contains a plurality of signal points having a plurality of kinds of amplitudes, and a second symbol which is the same symbol as the first symbol modulated using the modulation scheme but assigned to a signal point different from the any of a plurality of signal points; and a symbol demodulation unit which demodulates symbols to be demodulated, in a manner such that signal points of the symbols received by said symbol receiver are combined by mutual correspondence between the first symbols and the second symbols, respectively.

According to this embodiment, the same symbols assigned respectively to different signal points are combined in consideration of their respective correspondences, so that the energy at the time of the receiving can be increased. Thereby, the error rate can be reduced. Since the error rate is reduced, the number of retransmissions can be reduced, thereby enhancing the throughput.

The receiving apparatus may further comprise: a measurement unit which measures the signal strength of two symbols; and a selector which selects a larger signal strength among a plurality of signal strengths measured by the measurement. When the signal strength selected by the selector is greater than a threshold value for the signal strength, the symbol demodulation unit may demodulate a symbol corresponding to said signal strength; and when the signal strength selected by the selector is less than or equal to the threshold value, the symbol demodulation unit may demodulate the symbols to be demodulated in a manner such that the signal points of the symbols received by the symbol receiver are combined by mutual correspondence among the signal points of the symbols, respectively. According to this embodiment, when the propagation channel is in a good condition, a single symbol only is to be demodulated, so that the processing amount and the power consumption can be reduced.

The demodulation unit may combine the symbols assigned to the respective signals by varying the order of bits indicating quadrants of the respective signals to which the symbols have been assigned and the order of bits indicating placement within the quadrants. The symbol demodulation unit may multiply, per symbol, either one of an in-phase component and a quadranture component, whichever is different, by a weighting factor, for a plurality of bits contained in each symbol and then may combine the symbols assigned to the respective signal points. According to this embodiment, by employing a simplified processing, the symbols to be demodulated can be efficiently demodulated without the increase in circuit scale.

Still another embodiment of the present invention relates to a modulation method. This method includes: a first modulating of performing an arrangement processing in a manner that symbols to be transmitted are arranged to any of a plurality of signal points contained in a signal constellation by using a modulation scheme based on the signal constellation that contains the plurality of signal points having a plurality of kinds of amplitudes; and a second modulating of performing an arrangement processing in a manner that the same symbols as those in the first modulating are rearranged to signal points that differ from those arranged in the first modulation, by using the modulation scheme, wherein the signal points are contained in different quadrants from those in signal the constellation. According to this embodiment, the same symbols are assigned respectively to different signal points, so that the error probability in the positions of the signal points can be averaged in the receiving side.

Still another embodiment of the present invention relates to a demodulation method. This method includes: receiving a first symbol, assigned to any of a plurality of signal points contained in a signal constellation, by using a modulation scheme based on the signal constellation that contains a plurality of signal points having a plurality of kinds of amplitudes and a second symbol which is the same symbol as the first symbol modulated by using the modulation scheme but assigned to a signal point different from the any of a plurality of signal points; and demodulating symbols to be demodulated, in a manner such that signal points of the symbols received in the receiving are combined by mutual correspondence between the first symbols and the second symbols, respectively.

According to this embodiment, the same symbols assigned respectively to different signal points are combined in consideration of their respective correspondences, so that the energy at the time of the receiving can be increased. Thereby, the error rate can be reduced. Since the error rate is reduced, the number of retransmissions can be reduced, thereby raising the throughput.

Still another embodiment of the present invention relates to a demodulation apparatus. This demodulation apparatus comprises: a symbol receiver which receives a first symbol assigned to any of a plurality of signal points contained in a signal constellation, using a modulation scheme based on the signal constellation that contains a plurality of signal points having a plurality of kinds of amplitudes, and a second symbol which is the same symbol as the first symbol modulated using the modulation scheme but assigned to a signal point different from the any of a plurality of signal points; a preamble receiver which receives preambles corresponding respectively to the first symbol and the second symbol received by the symbol receiver; a signal-strength measurement unit which measures the signal strength of the first symbol and the second symbol received by the preamble receiver; and a symbol demodulation unit which demodulates the first symbol and the second symbol received by the symbol receiver, based on the signal strength of the respective preambles measured by the signal-strength measurement unit. When the degree of reliability of a symbol which has been demodulated in a manner such that the signal points of the symbols received by the symbol receiver are combined by mutual correspondence among the signal points of the symbols, respectively, is greater than or equal to a predetermined threshold value, the symbol demodulation unit outputs the symbol; and when the degree of reliability of a symbol which has been demodulated in a manner such that the signal points of the symbols received by the symbol receiver are combined by mutual correspondence among the signal points of the symbols, respectively, is less than the predetermined threshold value, the demodulation unit performs weightings corresponding to the degrees of reliability for the respective preambles measured by the signal-strength measurement unit on symbols corresponding respectively to the preambles and outputs the symbols which have been demodulated in a manner such that the signal points of the weighted symbols are combined by mutual correspondence among the signal points of the weighted symbols.

According to this embodiment, the same symbols assigned respectively to the different signal points are combined by switching the weighting methods, based on the signal strength of preambles, in the consideration of their respective correspondences. As a result, the energy at the time of the receiving can be increased and the receiving performance such as error rate can be improved.

Still another embodiment of the present invention relates also to a demodulation apparatus. This apparatus comprises: a symbol receiver which receives a first symbol assigned to any of a plurality of signal points contained in a signal constellation, using a modulation scheme based on the signal constellation that contains a plurality of signal points having a plurality of kinds of amplitudes, and a second symbol which is the same symbol as the first symbol modulated using the modulation scheme but assigned to a signal point different from the any of a plurality of signal points; a preamble receiver which receives preambles corresponding respectively to the first symbol and the second symbol received by the symbol receiver; a signal-strength measurement unit which measures the signal strength of the first symbol and the second symbol received by the preamble receiver; a symbol demodulation unit which demodulates symbols the first symbol and the second symbol received by the symbol receiver, based on the signal strength of the respective preambles measured by the signal-strength measurement unit; and a hard-decision unit which performs hard-decision processing on either the first symbol or the second symbol, received by the symbol receiver, whichever is larger in the signal strength and outputs a hard-decision value. When the hard-decision value outputted from the hard-decision unit agrees with that of a symbol demodulated in a manner such that the signal points of the symbols received by the symbol receiver are combined by mutual correspondence among the signal points of the symbols, respectively, the symbol demodulation unit outputs the symbol; and when the hard-decision value outputted from the hard-decision unit differs from that of a symbol demodulated in a manner such that the signal points of the symbols received by the symbol receiver are combined by mutual correspondence among the signal points of the symbols, respectively, the demodulation unit performs weightings corresponding to the signal strength of the respective preambles measured by the signal-strength measurement unit on symbols corresponding respectively to the preambles and outputs the symbols which have been demodulated in a manner such that the signal points of the weighted symbols are combined by mutual correspondence among the signal points of the weighted symbols. According to this embodiment, when the decision by the hard-decision value agrees with the decision by the combining, the combining processing that includes the weighting is not performed. Thereby, the processing amount can be reduced without affecting the receiving performance.

The symbol demodulation unit may combine the symbols assigned to the respective signals by varying the order of bits indicating quadrants of the respective signals to which the symbols have been assigned and the order of bits indicating placement within the quadrants. The symbol demodulation unit may multiply a plurality of bits contained in the respective symbols by different weighting factors, respectively, and then combine the symbols assigned respectively to the signal points. Among a plurality of symbols, the symbol demodulation unit may multiply a symbol, assigned to a signal point whose distance from the origin is far, by a larger weighting factor than those for the other symbols, and then combine the symbols. According to this embodiment, the symbols are combined by changing the order of bits. As a result, the symbols to be demodulated can be efficiently demodulated without causing the increase in circuit scale. Also, a symbol assigned to a signal point whose distance from the origin is farther away is multiplied by a larger weighting factor. As a result, the energy of a symbol having a higher degree of reliability can be raised, thereby improving the receiving characteristics.

Still another embodiment of the present invention relates to a demodulation method. This method includes: receiving a first symbol assigned to any of a plurality of signal points contained in a signal constellation, by using a modulation scheme based on the signal constellation that contains a plurality of signal points having a plurality of kinds of amplitudes, and a second symbol which is the same symbol as the first symbol modulated by using the modulation scheme but assigned to a signal point different from the any of a plurality of signal points; measuring the signal strength of preambles corresponding respectively to the first symbol and the second symbol; and demodulating the first symbol and the second symbol, either in a manner such that signal points of the received symbols are combined by mutual correspondence between the first symbols and the second symbols, respectively, or in a manner such that weightings corresponding to the signal strength of the respective preambles measured by the measuring are performed on symbols corresponding respectively to the preambles and then the signal points of the weighted symbols are combined by mutual correspondence among the signal points of the weighted symbols.

When the degree of reliability of a symbol which has been demodulated in a manner such that the signal points of the received symbols are combined by mutual correspondence among the signal points of the symbols, respectively, is greater than or equal to a predetermined threshold value, the demodulating may output the symbol; and when the degree of reliability of a symbol which has been demodulated in a manner such that the signal points of the received symbols are combined by mutual correspondence among the signal points of the symbols, respectively, is less than the predetermined threshold value, the demodulating may be such that weightings corresponding to the measured signal strength of the respective preambles are performed on symbols corresponding respectively to the preambles and then the demodulated symbols are outputted by combining the symbols by mutual correspondence among the signal points of the weighted symbols.

Of the respective symbols received by the receiving, the demodulating may perform a hard-decision processing on a symbol whose signal strength is larger and output a hard-decision value; and when the outputted hard-decision value agrees with that of a symbol demodulated in a manner such that the signal points of the received symbols are combined by mutual correspondence among the signal points of the symbols, respectively, the demodulating may output the symbol, and when the outputted hard-decision value differs from that of a symbol demodulated in a manner such that the signal points of the received symbols are combined by mutual correspondence among the signal points of the symbols, respectively, the demodulating may be such that weightings corresponding to the signal strength of the respective preambles measured by the measuring on symbols corresponding respectively to the preambles and the symbols, which have been demodulated in a manner such that the signal points of the weighted symbols are combined by mutual correspondence among the signal points of the weighted symbols, are outputted.

The demodulating may be such that the symbols assigned to the respective signals are combined by varying the order of bits indicating quadrants of the respective signals to which the symbols have been assigned and the order of bits indicating placement within the quadrants. The demodulating may be such that a plurality of bits contained in the respective symbols are multiplied by different weighting factors, respectively, and then the symbols assigned respectively to the signal points are combined. The demodulating may be such that among a plurality of symbols received by the receiving, a symbol, assigned to a signal point whose distance from the origin is far, is multiplied by a larger weighting factor than those for the other symbols, and then the symbols are combined.

It is to be noted that any arbitrary combination of the above-described structural components and expressions converted among a method, an apparatus, a system, a recording medium, a computer program and so forth are all effective as and encompassed by the present embodiments.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 illustrates an example of a structure of a communication system according to an embodiment of the present invention;

FIGS. 2A to 2E illustrate examples of structures of a burst format according to an embodiment of the present invention;

FIGS. 3A to 3E illustrate examples of hopping frequencies and hopping patterns according to an embodiment of the present invention;

FIGS. 4A to 4E illustrate an example of operational processing for a baseband modulation unit shown in FIG. 1;

FIG. 5 illustrates an example of a structure of a baseband demodulation unit shown in FIG. 1;

FIG. 6 illustrates an example of a structure of a demodulation execution unit shown in FIG. 5;

FIG. 7 shows an example of a structure of a symbol demodulation unit shown in FIG. 6;

FIG. 8 shows an example of symbol areas to be received by a symbol receiver shown in FIG. 6;

FIG. 9 illustrates a performance example of a demodulation execution unit shown in FIG. 5;

FIG. 10 is a flowchart showing an example of an operation of a baseband demodulation unit shown in FIG. 5;

FIGS. 11A to 11C illustrate a modification over FIGS. 4C to 4E;

FIGS. 12A to 12C illustrate another modification over FIGS. 4C to 4E; and

FIG. 13 shows a modification of a symbol demodulation unit shown in FIG. 7.

### DETAILED DESCRIPTION OF THE INVENTION

The invention will now be described by reference to the preferred embodiments. This does not intend to limit the scope of the present invention, but to exemplify the invention.

An outline of embodiments of the present invention will be given before a detailed description thereof. The embodiments of the present invention relate to a communication system that uses different modulation schemes, respectively, when a plurality of the same data are transmitted. The present embodiments can be applied to high-speed data communication system such as UWB that uses the Orthogonal Frequency Division Multiplex (OFDM) scheme.

In a multi-level modulation, particularly QAM modulation, the error resilience or error tolerance generally differs depending on the signal points arranged. The QAM modulation is a modulation scheme in which the signals are arranged in a lattice with the origin as the center thereof. The error resilience increases proportional to the distance between signal points or the distance from the origin. However, since the arrangement rule or constellation rule of signal points is determined by the location of bits that constitute symbols, the signals to be assigned will be fixed by the symbols. As a result, the error rate of the symbols that correspond to signals whose error resilience is low deteriorates constantly in the receiving side. As a result thereof, said symbols must be retransmitted, thus reducing the throughput.

Accordingly, in the embodiments of the present invention, the signal points to be arranged by the symbols are not fixed, and the symbols arranged in the signal points whose error resilience is low is reduced. Though the details will be described later, the bit assignment within each symbol in the QAM modulation and the arrangement rule for signal points are varied per transmission. This can prevent any particular symbol from constantly exhibiting the low error resilience and therefore the error rate can be reduced and the throughput can be enhanced. Also, in light of arrangement rule, the weighting is performed, in the receiving side, in accordance with the receiving quality for each symbol.

Though the communication processing in the present embodiments are used for UWB (Ultra Wide Band) here as an example, the present invention is not limited thereto. The UWB is a communication technique that utilizes ultra wide bands. In the Federal Communications Commission (FCC) in the U.S., UWB is a radio communication defined such that more than or equal to 20% of the central frequency is used as a 10 dB bandwidth, or the bandwidth of 500 MHz or more is used.

In the MB-OFDM (Multi-Band OFDM) scheme where one such scheme as OFDM scheme is combined with the frequency hopping (FH) scheme, the spectrum of 3.1 GHz to 10.6 GHz is divided into 14 bands, so that 528 MHz is assigned to each band. Each band is further composed of 128 carrier waves. By switching between the respective bands at high speed, the average communication power within the band is lowered so as to help reduce the power consumption.

A description is now given of OFDM. OFDM is one type of multi-carrier modulation schemes and is a communication method where the multiplicity of digital modulation signals obtained after the carriers of mutually different frequencies are digital-modulated are added up so as to generate and transmit a plurality of subcarrier signals. The OFDM is used for UWB, terrestrial digital broadcast, the wireless LAN (Local Area Network) such as IEEE 802.11a, and a transmission system such as a power line modem.

In FDM, the high-rate data signals are converted to a plurality of low-rate data signals of narrow band and then transmitted in parallel on the frequency axis. In OFDM, however, the overlapping is permitted on the frequency axis utilizing the orthogonality. Since in OFDM a plurality of carriers are densely arranged in a manner that they are partially overlapped to one another without causing the interference thereamong, the wideband transmission utilizing the narrow frequency range efficiently is achieved, thus raising the frequency utilization efficiency.

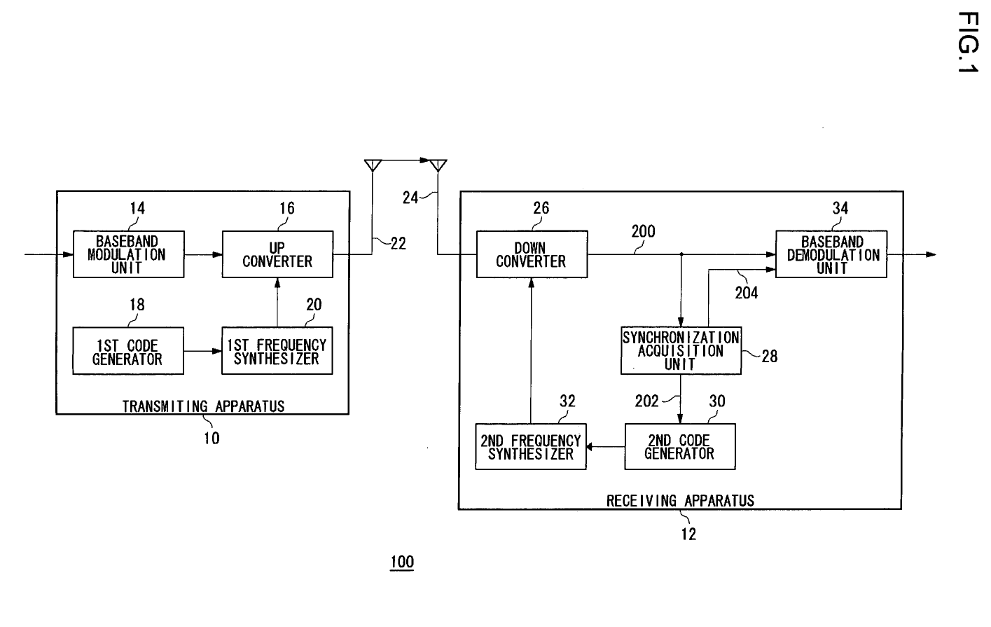

FIG. 1 illustrates an example of a structure of a communication system 100 according to an embodiment of the present invention. The communication system 100 includes a transmitting apparatus 10 and a receiving apparatus 12. The transmitting apparatus 10 includes a baseband modulation unit 14, an up-converter 16, a first code generator 18, a first frequency synthesizer 20 and an antenna 22 for use with transmission (hereinafter referred to as a transmitting antenna 22 also). The receiving apparatus 12 includes an antenna 24 for use with receiving (hereinafter referred to as a receiving antenna 24 also), a down-converter 26, a synchronization acquisition unit 28, a second code generator 30, a second frequency synthesizer 32, and a baseband demodulation unit 34. Signals involved herein include a baseband signal 200, a synchronization pattern signal 202 and a synchronization timing signal 204.

The baseband modulation unit 14 modulates data signals, using such modulation schemes as 16-QAM. The baseband modulation unit 14 places a preamble at a header portion of a burst signal. The detailed description of the format of a burst signal, the constitution of a preamble and the modulation processing will be given later. The first code generator 18 generates pseudo-random code signals, and the first frequency synthesizer 20 generates randomly-hopping carriers according to the pseudo-random code signals.

The up-converter 16 turns modulated signals into frequency-hopped signals, using the randomly-hopping carriers. The transmitting antenna 22 transmits the frequency-hopped signals. The receiving antenna 24 receives signals transmitted from the transmitting antenna 22. The second frequency synthesizer 32, like the first frequency synthesizer 20, generates randomly-hopping carriers, and the down-converter 26 frequency-converts the received signals, using the randomly-hopping carriers. The frequency-converted signals are outputted as baseband signals 200.

Here, if the frequency hopping pattern of carriers generated by the first frequency synthesizer 20 agrees with that of carriers generated by the second frequency synthesizer 32, the down-converter 26 can perform a frequency conversion on received signals accurately. If, on the other hand, they do not agree, the down-converter 26 cannot perform a frequency conversion thereon. Thus, to ensure an accurate frequency conversion of received signals, the synchronization acquisition unit 28 synchronizes the frequency hopping pattern of carriers generated by the second frequency synthesizer 32 with the frequency hopping pattern of received signals.

An instruction signal concerning the synchronization of hopping patterns is outputted as a synchronization pattern signal 202. Further, the synchronization acquisition unit 28 determines an FFT (Fast Fourier Transform) window for a received signal and outputs the thus determined FFT window as a synchronization timing signal 204.

The baseband demodulation unit 34 performs a demodulation processing on a burst signal, based on the FFT window determined by the synchronization acquisition unit 28. The demodulation processing is done in correspondence to the modulation processing at the baseband modulation unit 14, so that it includes FFT for instance.

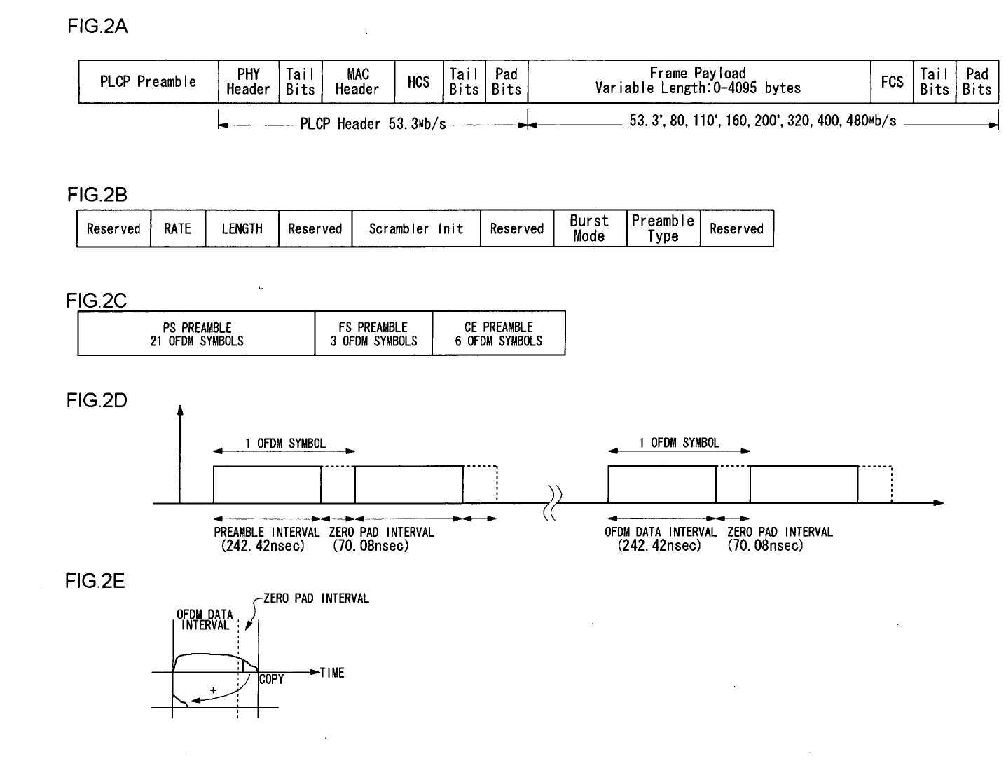

FIGS. 2A to 2E illustrate examples of structures of a burst format according to an embodiment of the present invention. FIG. 2A shows a burst format of an MB-OFDM scheme. The horizontal axis of the format represents time. A frame is roughly divided into a preamble part, a header part and a data part. The preamble part corresponds to “PLCP Preamble” in FIG. 2A, the header part corresponds to “PLCP Header” in FIG. 2A and the data part corresponds to “Frame Payload” in FIG. 2A. The respective parts are transmitted at transmission rates indicated in FIG. 2A.

Frames are assigned in the order from the top: “PLCP Preamble”, “PLCP header” and “Payload”. Here, “PLCP preamble” corresponds to a training signal used for timing-synchronization and the like. “PLCP Header” corresponds to a control signal. “Payload” corresponds to a data signal. They are each composed of a predetermined number of symbols. Although the transmission rate for “PLCP Preamble” and “PLCP Header” is set in advance to 53.3 Mbps or 55 Mbps, the transmission rate for “Payload” is set variably.

FIG. 2B shows a constitutional example of “PHY Header” contained in “PLCP Header”. From the top thereof, “Reserved”, “RATE”, “LENGTH”, “Reserved”, “Scrambler Init”, and “Reserved” are assigned in this order. Here, “RATE” indicates the transmission rate of “Payload”. “LENGTH” represents the data length of “Payload” and “Scrambler Init” an initial value of the scrambler. The transmitting apparatus 10 recognizes the transmission rate of “Payload” by referring to “RATE” in “PLCP Header”.

FIG. 2B shows a constitutional example of “PLCP Preamble”. The preamble part includes a “PS preamble”, an “FS preamble” and a “CE preamble”. The “PS preamble”, “FS preamble” and “CE preamble” are composed of “21 OFDM symbols”, “3 OFDM symbols” and “6 OFDM symbols”, respectively. Here, the “OFDM symbol” includes the unit of signals outputted as a result of FFT processing, and the like. The details will be discussed later. In what is to follow, “PS preamble” will be denoted by a “first known stream”, and “FS preamble” will be denoted by a “second known stream” and “CE preamble” will be denoted by a “third known stream”.

The first known stream is generally used for initial synchronization, initial frequency error measurement, the setting of AGC, and the like, and is defined in the time domain. The first known stream includes a plurality of symbols having the same known pattern for each carrier. Since the number of carriers is 3 here, each carrier contains 7 OFDM symbols. The second known stream is a preamble used to establish the synchronization of frames assigned posterior to the first known stream, and it is composed of data where the phase of the first known stream is inverted.

In the second known stream, 1 OFDM symbol is contained for each carrier. The second known stream is defined in the frequency domain and is used for channel estimation and the like. When the channel estimation and the data demodulation of OFDM-modulated data are performed in the second known stream, data part is extracted at an appropriate timing and the FFT is performed. Here, in the case of UWB, 128-point FFT is used, so that an FFT window corresponds to a data duration of 128 samples.

In a first known stream interval, a synchronization processing for determining an FFT execution range and the like are performed. However, at what point the synchronization has been effected in the first known stream is indeterminate. Hence, the channel estimation is performed in a third known stream. Further, when the demodulation processing is performed on the PAYLOAD data, it is necessary to find a boundary of the third known stream and then synchronize the frame timing.

According to the present embodiment, the boundary between the first known and the second known stream transmitted as a signal where the polarity of the first known signal has been inverted is detected by an appropriate processing in order to find a boundary with the third known stream. Then, the end timing of the second known stream is derived from the detected boundary so as to derive the end timing of the third known stream.

FIG. 2D illustrates a structural example of an OFDM symbol. An OFDM symbol has a duration of 312.5 nsec. This corresponds to 165 samples at a sample rate of 528 Mbps. In this OFDM symbol, a preamble or OFDM data is placed in the former duration of 242.42 nsec, and “0” is inserted in the latter duration of 70.08 nsec.

This zero pad duration corresponds to a guard interval of the OFDM symbol. It is to be noted that 9.47 nsec at the end of the zero pad duration of 70.08 nsec are defined as a switch period for frequency switching. Accordingly, the duration of the guard interval is defined to be 60.61 nsec. The switch duration is equivalent to 5 samples whereas the duration of the guard interval is equivalent to 32 samples.

FIG. 2E illustrates a concept of a guard interval. According to the IEEE 802.11a standard or the like, a guard interval is placed anterior to an OFDM data interval. Part of the OFDM data values is used as the value of guard interval. In the MB-OFDM scheme according to the present embodiment, a zero pad interval is placed posterior to an OFDM data as shown in FIG. 2D. However, as shown in FIG. 2E, of the received OFDM symbols, the data in the zero pad interval is added to the OFDM data and then subjected to FFT. As a result, the multipath interference is equalized the same way as with cyclic prefix.

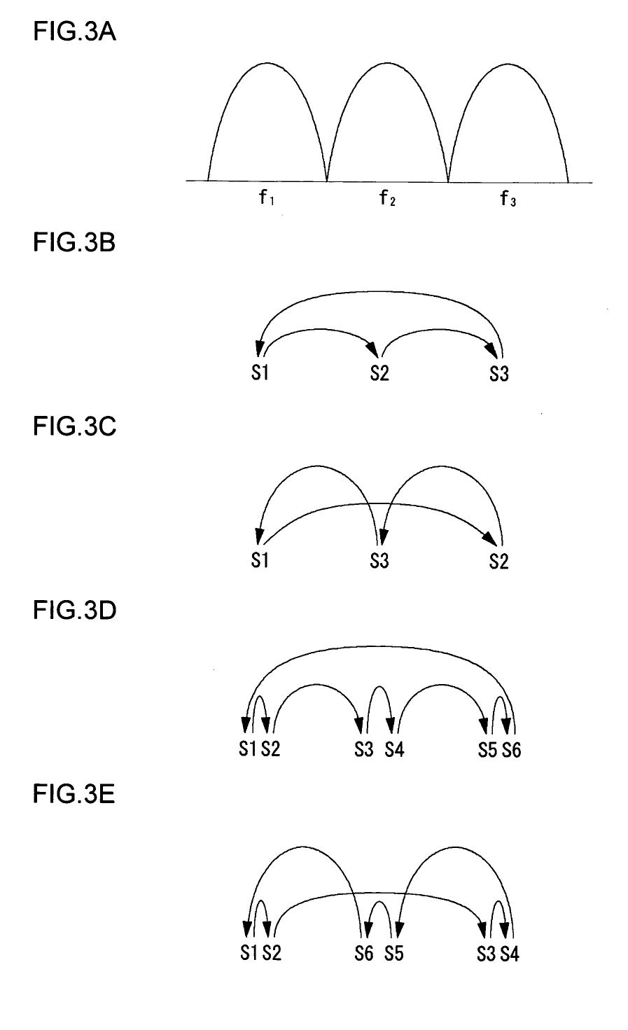

FIGS. 3A to 3E illustrate examples of hopping frequencies and hopping patterns according to an embodiment of the present invention. Note that these are for UWB. FIG. 3A shows hopping frequencies under consideration here. They are frequencies “f1”, “f2” and “f3”. FIG. 3B shows a first hopping pattern. In a duration of 6 symbols, a frequency hopping takes place in the order of “f1”→“f2”→“f3”→“f1”→“f2”→“f3”. Here the timing of the respective symbols is denoted by “S1” to “S3”.

FIG. 3C shows a second hopping pattern. In a duration of 6 symbols, a frequency hopping takes place in the order of “f1”→“f3”→“f2”→“f1”→“f3”→“f2”. FIG. 3D shows a third hopping pattern. In a duration of 6 symbols, a frequency hopping takes place in the order of “f1”→“f1”→“f2”→“f2”→“f3”→“f3”. FIG. 3E shows a fourth hopping pattern. In a duration of 6 symbols, a frequency hopping takes place in the order of “f1”→“f1”→“f3”→“f3”→“f2”→“f2”.

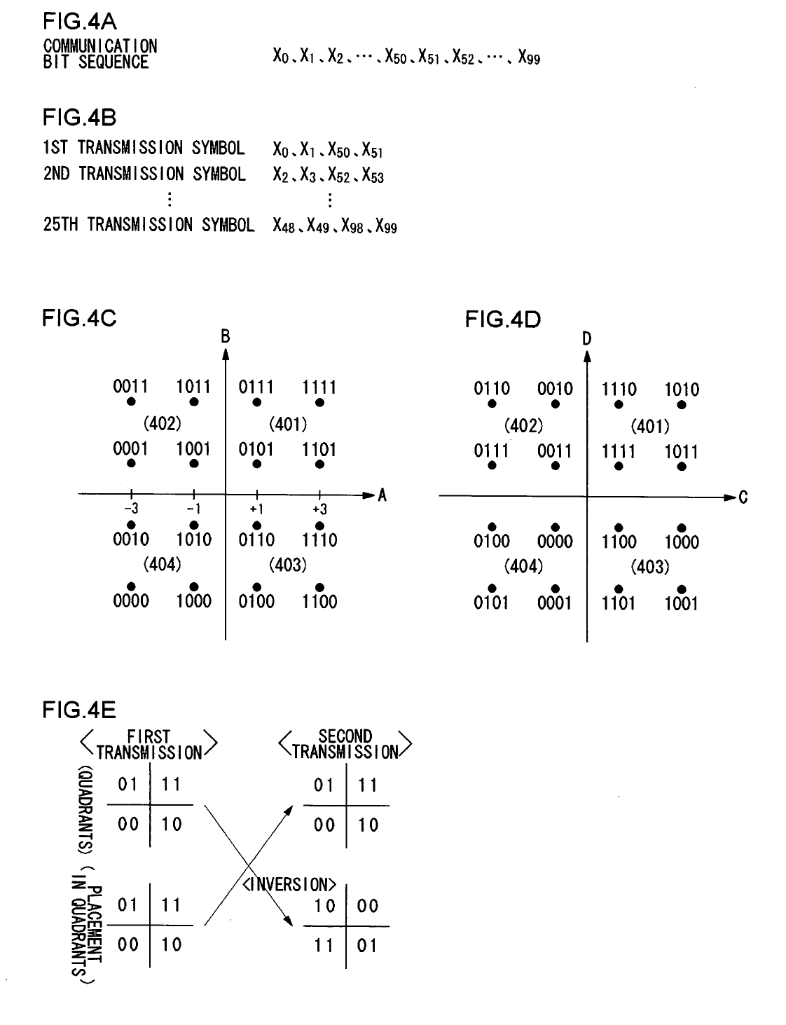

FIGS. 4A to 4E illustrate an example of operational processing for a baseband modulation unit 14. It is assumed herein that 4 bits make one symbol and 16-QAM modulation is performed. FIG. 4A illustrates a transmission bit sequence, and it is assumed herein that 100 bits of X₀ to X₉₉ are to be transmitted. FIG. 4B illustrates a configuration example of each symbol where one symbol is composed of 4 bits when a transmission bit sequence composed of 100 bits as shown in FIG. 4A is to be transmitted. FIG. 4C shows an example of a first signal constellation at the time of a first transmission of each symbol shown in FIG. 4B. FIG. 4D shows an example of a second signal constellation at the time of a second transmission of each symbol shown in FIG. 4B. FIG. 4E shows a relationship between FIG. 4C and FIG. 4D.

Using an example, a description will now be given of an operational processing for the baseband modulation unit 14. If a transmission symbol is composed of 4 bits {1 0 1 0}, in the first signal constellation shown in FIG. 4C it will be assigned to a signal point located at the upper right part of four signal points in the fourth quadrant. In the second signal constellation shown in FIG. 4D, on the other hand, it will be assigned to a signal point located at the upper right part of four signal points in the first quadrant.

In general, the signal constellation in 16-QAM is such that for the symbols assigned to the signal points {1 0 0 1}, {0 1 0 1}, {1 0 1 0} and {0 1 1 0}, in the first signal constellation shown in FIG. 4C, which are located closer to the origin there are eight signals surrounding each of these four signal points and it is probable that each of these four signal gets closer to those eight signals in the receiving side. If that happens, each of these four signals may often be determined as any of those eight signals and therefore these four signal points are said to be signal points which are prone to the error.

On the other hand, for example, in the case of the symbols assigned to the signal points {0 0 1 1}, {1 1 1 1}, {0 0 0 0} and {1 1 0 0} there are only three signal points surrounding each of these four signal points and therefore the probability that the error occurs with these four points is said to be lower as compared with the other signal points.

Thus, it is preferable that the symbols assigned to the signal points {1 0 0 1}, {0 1 0 1}, {1 0 1 0} and {0 1 1 0} which are located close to the origin at the first transmission as shown in FIG. 4C be assigned to the signal points located far away from the origin, at the second transmission, namely any of signal points at four corners of lattice-like signal constellation. On the other hand, it is preferable that the symbols assigned to the signal points located far away from the origin at the first transmission be assigned to the signal points located closer to the origin. By implementing such an embodiment as this, the error resilience is averaged between signal points and the error rate is lowered averagely.

Also, the arrangement may be such that the distances between the signal points are set far between the first transmission and the second transmission. For example, it is preferable that the symbol {1 0 0 1} assigned to the signal point located at the lower right part in the second quadrant 402 at the first transmission as shown in FIG. 4C be assigned to the signal point located at the lower right part in the third quadrant 403 at the second transmission. In other words, the signal points assigned at the first and the second transmission are located across the origin and may be assigned in a manner that the distance between the signal points gets far. Thereby, the symbols assign to the signal points located closer to the origin at the first transmission are assigned to the signal points located far away from the origin at the second transmission. As a result, the error resilience is averaged and the error rate as a whole can be reduced.

A description will now be given of a relationship between the first signal constellation shown in FIG. 4C and the second signal constellation shown in FIG. 4D using equations. Firstly, each bit contained in the bit sequence to be transmitted is converted to a signed code. For instance, when the bit is “0”, it is converted to “−1”; when the bit is “1”, it is converted to “+1”. Here, the four bits of a transmitting signal after the conversion are denoted by x[k], x[k+1], x[k+n], and x[k+n+1], and the two signal constellations d[k] and d[k+n] are expressed by Equations (1) and (2).

Here, k and n are each a positive integer, and m₀ to m₄ are weighting factors. a is a normalized coefficient relative to m₀ to m₄. By relating one signal constellation to the other signal constellation in this manner, it is possible to differentiate, per transmission, signal points to which the symbols are to be assigned. Note that a description will be given below on the assumption that m₀=(−m₃)=1 and m₁=m₂=2.

$$\begin{matrix}( \begin{matrix}d [ k ] \\ d [ k + n ]\end{matrix} ) = A \cdot ( \begin{matrix}x ( k ) + j \cdot x ( k + n ) \\ x ( k + 1 ) + j \cdot x ( k + n + 1 )\end{matrix} ) & ( 1 ) \\ A = a \cdot ( \begin{matrix}{m}_{0} & {m}_{1} \\ {m}_{2} & {m}_{3}\end{matrix} ) & ( 2 )\end{matrix}$$

Here, m₁ and m₂ are each twice as much as m₀, and the sign of m₃ is the reverse of the sign of m₀. That is, at the first transmission the weighting is performed on the imaginary axis, namely the quadrature components. On the other hand, at the second transmission the weighting is performed on the real axis, namely the in-phase components.

As a result thereof, the distances of the signal points to be assigned in the first and the second transmission can be set far. Since the sign of m₃ is the reverse of the sign of m₀, the quadrants on which the signal points are to be assigned can be made to differ at the first and the second transmission. With these operations as described above, the symbols are assigned respectively to the signal points that exhibit different error resiliences. The relation among m₀ to m₃ is not limited to the above, and at the first and the second transmission the relation may be such that the weighting is performed on either one of the in-phase component and the quadrature component and the sign is inverted.

Now, the relationship between the first signal constellation shown in FIG. 4C and the second signal constellation shown in FIG. 4D will be explained from a different point of view. Suppose in the signal constellation that the bits indicating each quadrant are {I0, Q0} which represent a first bit and a third bit, respectively. Suppose also that the bits indicating the location in each quadrant are {I1, Q1} which represent a second bit and a fourth bit, respectively. Note that I0 and I1 indicate real-axis coordinates. Here, the signal constellation shown in FIG. 4 in each quadrant is expressed by the following Equations (3) to (6).
The first quadrant 401: {I0, Q0}={1 1} (3)
The first quadrant 402: {I0, Q0}={0 1} (4)
The first quadrant 403: {I0, Q0}={1 0} (5)
The first quadrant 404: {I0, Q0}={0 0} (6)

Here, if in each quadrant a signal point in the upper-right position is the first quadrant, a signal point in the lower-right position is the second quadrant, a signal in the upper-left position is the third quadrant and a signal in the lower-left position is the fourth quadrant, then the same relation as Equation (3) to (6) will hold. Hence, the first signal constellation shown in FIG. 4C is expressed, as follows, using I0, Q0, I1 and Q1.
{I1, I0, Q1, Q0} (7)

Similarly, the second signal constellation shown in FIG. 4D is expressed, as follows, using I0, Q0, I1 and Q1. Here, “ˆX” denotes a bit of which X is logic-inverted.
{ˆI0, I1, ˆQ0, Q1} (8)

That is, the relation is such that (a) the positions of I0 and I1 are reversed between the first signal constellation shown in FIG. 4C and the second signal constellation shown in FIG. 4D, (b) the position of Q0 and Q1 is reversed, and (c) logic is inverted in I0 and Q0. This relation stated just now is illustrated in FIG. 4E. In other words, in order to assign the same symbols to different signal points, respectively, there may be two ways to do it.

That is, as shown in Equation (1), a matrix operation using the weighting factors is performed so as to be modulated to the first signal constellation shown in FIG. 4C and the second signal constellation shown in FIG. 4D. First, the symbols are assigned to the first signal constellation shown in FIG. 4C. Then, in the bit sequence of each symbol to be transmitted, a first bit and a second bit are switched around. A third bit and a fourth bit are switched around. Then the first bit and the third bit after the reversal are subjected to the logic inversion processing. Finally, the symbols are assigned to the first signal constellation shown in FIG. 4C.

FIG. 4E illustrates the above-described relation. FIG. 4E shows a relation, per transmission, between the bits indicating “quadrants” and those indicating “assignment in the quadrants”. The “quadrants” in FIG. 4E show the bit structures where the four quadrants are each represented by two bits. For example, an upper-right quadrant is expressed by the bit “11”. In 16-QAM, there are four signal signals in each quadrant. The “assignment in the quadrants” in FIG. 4E shows a case where the arrangement of four signals are each expressed by two bits and, for example, the signal point in the lower right is expressed by “10”.

At the first transmission, of 4 bits constituting a symbol, the second bit and the fourth bit indicate a quadrant. The first bit and the third bit indicate a placement in the quadrant. Here, at the second transmission, of 4 bits constituting a symbol, the first bit and the third bit indicate a quadrant. The second bit and the fourth bit indicate a placement in the quadrant. That is, as described above, the bits indicative of the quadrant and the bits indicative of the placement in the quadrant are rearranged, namely switched around, at the second transmission.

The arrangement in a quadrant at the second transmission is so structured that the arrangement in a quadrant at the first transmission is logic-inverted. Thereby, the same symbols at the second transmission may be assigned to the signal points located farthest from and across the origin, as compared with those assigned at the first transmission. Note that the “first” and “second” may indicate the frequency band to be assigned in the up-converter of FIG. 1 or may indicate the before and after in time.

In the case where the “first” and “second” indicate the frequency band to be assigned in the up-converter of FIG. 1, the symbols at the “first” transmission are assigned to a lower frequency band, whereas the symbols at the “second” transmission are assigned to a higher frequency band. In what is to follow, a description will be given on the assumption that the “first” and “second” indicate the frequency band to be assigned in the up-converter of FIG. 1.

The above-described method differs depending on a matrix that contains weighting factors in the right-hand side in Equation (1). That is, the relation between (7) and (8) is determined by a relation between two signal constellations. In other words, two signal constellations are given a correspondence therebetween by Equation (1) or (7) and (8), so that the two signal constellations for the same symbols can be produced using a simple method. By this correspondence, the error rate for each signal point can be averaged and, furthermore, the same symbols can be assigned respectively to different signal points. Thus, the error rate can be reduced. The details will be discussed later.

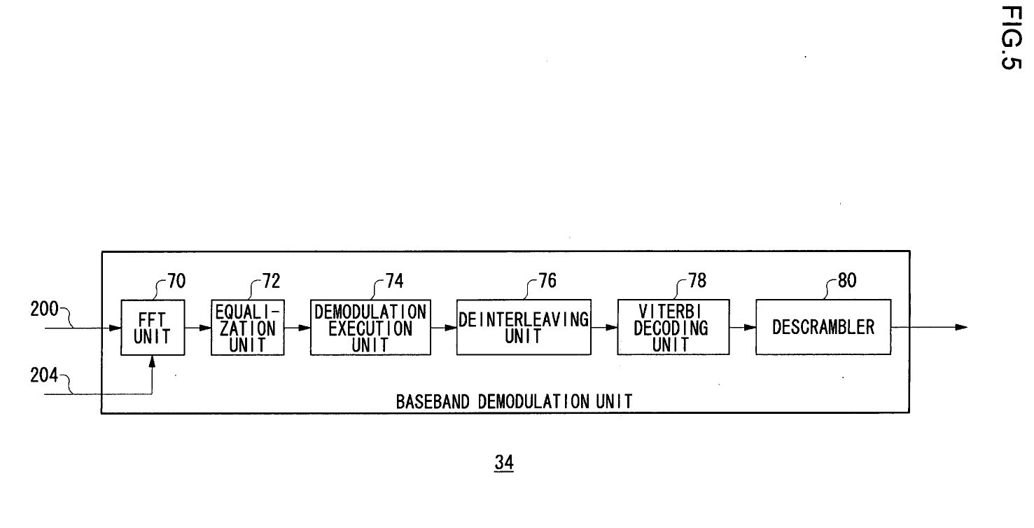

FIG. 5 illustrates an example of a structure of the baseband demodulation unit 34. The baseband demodulation unit 34 includes an FFT unit 70, an equalization unit 72, a demodulation execution unit 74, a deinterleaving unit 76, a Viterbi decoding unit 78 and a descrambler 80.

The FFT unit 70 performs a Fourier transform on the OFDM symbols subsequent to the preamble in a baseband signal 200, based on the FFT window detected by the synchronization acquisition unit 28. That is, the FFT unit 70 transforms a baseband signal 200, which is defined as a time-domain signal, into a frequency-domain signal. In that process, the FFT unit 70 specifies an OFDM data interval by the FFT window and carries out a processing on the zero pad interval as shown in FIG. 2E. The equalization unit 72 carries out an equalization on a frequency-domain signal. The deinterleaving unit 76, the Viterbi decoding unit 78 and the descrambler 80 carry out deinterleaving, Viterbi decoding and descrambling, respectively, in correspondence to the transmitting apparatus 10 of FIG. 1. Here, the processing of the descrambler 80 may be performed using known technologies, so that the description thereof is omitted.

The equalization unit 72 performs channels estimation on the preamble signals among the signals outputted from the FFT unit 70. This channel estimation is performed on the preamble signals associated with each of the same symbols as many times as the number of transmission for the symbols. The channel estimation may be done using a known technique, and the indicators, such as SNR (Signal-to-Noise Ratio) and RSSI (Received Signal Strength Indicator) indicative of the quality are measured so as to be outputted to the demodulation execution unit 74.

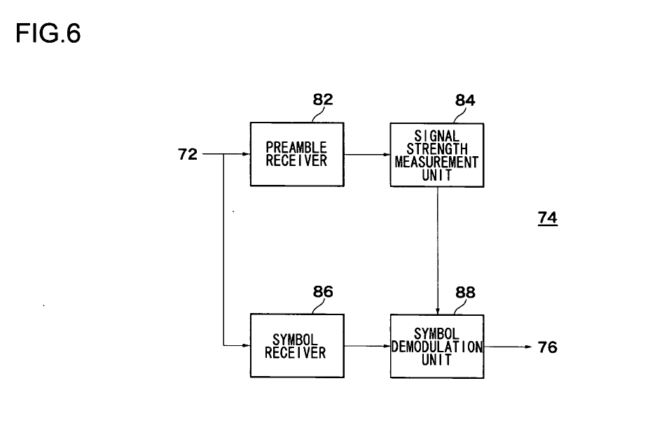

FIG. 6 illustrates an example of a structure of the demodulation execution unit 74 shown in FIG. 5. The demodulation execution unit 74 includes a preamble receiver 82, a signal strength measurement unit 84, a symbol receiver 86 and a symbol demodulation unit 88. The preamble receiver 82 receives preambles corresponding respectively to two symbols received by the symbol receiver 86. The signal strength measurement unit 84 measures the signal strengths of the respective preambles received by the preamble receiver 82.

The symbol receiver 86 receives two symbols assigned respectively to different signal points, using a modulation scheme such as 16-QAM. These two symbols are symbols for the same data, as described above. The symbol demodulation unit 88 demodulates the respective symbols received by the symbol receiver 86, based on the signal strengths of the respective preambles measured by the signal strength measurement unit 84.

Though the details will be described later, the symbol demodulation unit 88 combines them by mutually associating the signal points of the respective symbols received by the symbol receiver 86. Here, if the degree of reliability for a demodulated symbol is greater than or equal to a predetermined threshold value, the symbol will be outputted directly to the deinterleaving unit 76. If, on the other hand, the degree of reliability for a demodulated symbol is less than the predetermined threshold value, the weightings corresponding respectively to the signal strengths of preambles measured by the signal strength measurement unit 84 are given to the symbols corresponding respectively to the preambles, and the signal points of the weighted symbols are mutually brought into correspondence so as to be combined. Thereby the demodulated symbols are outputted.

Here, “combining” may be done in a manner that the order of both the bits indicative of quadrants that indicate the signal points to which the symbols are assigned and the bits indicative of the arrangement in the quadrants is changed. After a plurality of bits contained in the respective symbols are multiplied respectively by different weighting factors, the symbols assigned respectively to the signal points may be combined. Of a plurality of symbols received by the symbol receiver 86, the symbols assigned to the signal points whose distance from the origin are farther away may be multiplied by weighting factors which are larger than those for the other symbols and, thereafter, they may be combined.

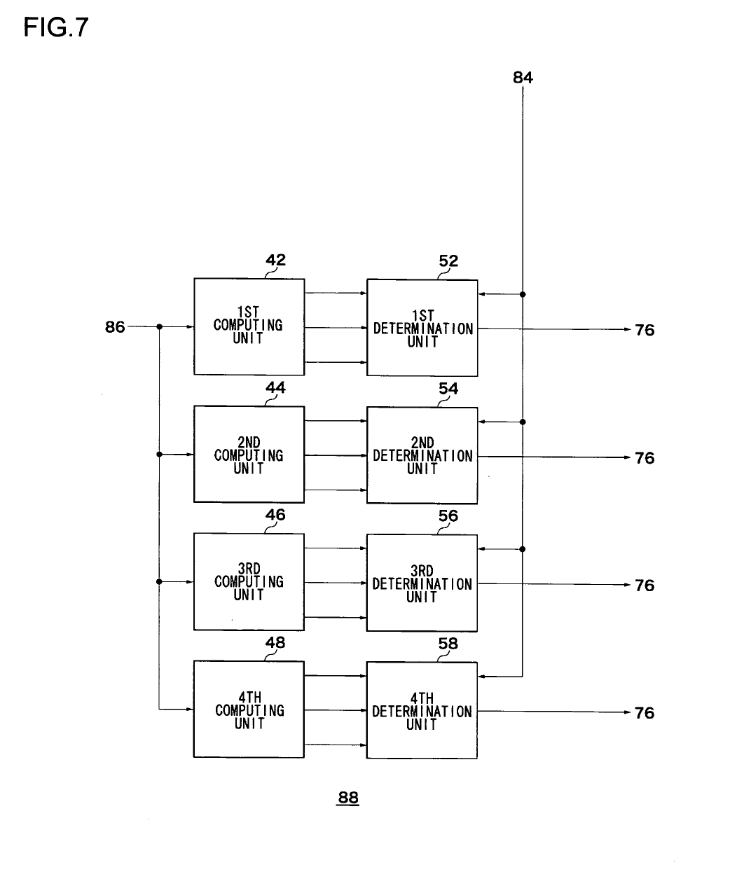

FIG. 7 shows an example of a structure of the symbol demodulation unit 88 shown in FIG. 6. The symbol demodulation unit 88 includes a first computing unit 42 to a fourth computing unit 48, which are represented by a computing unit 40, and a first determination unit 52 to a fourth determination unit 58, which are represented by a determination unit 50. The computing unit 40 combines two symbols received in the symbol receiver 86.

The combining of symbols includes the combining in consideration of signal constellation at the time of modulation (hereinafter referred to as “first combined symbol”), the combining in consideration of the weighting given to one of received symbols and signal constellation at the time of modulation (hereinafter referred to as “second combined symbol”), and the combining in consideration of the weighting given to the other of received symbols and signal constellation at the time of modulation (hereinafter referred to as “third combined symbol). The first determination unit 52 selects any of three symbols combined by the computing unit 40 according to the signal strength of a preamble notified from the signal strength measurement unit 84, and outputs the selected symbol to the deinterleaving unit 76.

Though the details will be discussed later, if the signal strength of a preamble is greater than or equal to a predetermined threshold value, the determination unit 50 will select a first combined symbol and output it to the deinterleaving unit 76. If the signal strength of a preamble is less than the predetermined threshold value and if the signal strength of a first-half preamble signal is smaller than that of a second-half preamble signal, the determination unit 50 will select a second combined symbol obtained by multiplying the symbol for the first-half preamble signal by the weighting factor of less than 1 and then output it.

If the signal strength of a preamble is less than the predetermined threshold value and if the signal strength of the second-half preamble signal is smaller than that of the first-half preamble signal, the determination unit 50 will select a second combined symbol obtained by multiplying the symbol for the second-half preamble signal by the weighting factor of less than 1 and then output it. The “first-half preamble signal” is a preamble signal that corresponds to a symbol assigned to a lower frequency side at the time when the same symbols are transmitted simultaneously. The “second-half preamble signal” is a preamble signal that corresponds to a symbol assigned to a higher frequency band.

An operation of the computing unit 40 will now be described in detail. First, assume that the assignments of two signal points for the same symbol are y[k] and y[k+n] and soft-decision bits contained in a transmission symbol having the noise are x′[k], x′[k+1], x′[k+n] and x′[k+n+1]. As a result, the relation among these is expressed as the following Equation (9), based on Equation (1). In the following Equation (8), m₀ to m₃ are such that m=m₀=−m₃ and m₁=m₂=+1.

$$( \begin{matrix}{y}_{i} [ k ] + {y}_{q} [ k ] \\ {y}_{i} [ k + n ] + {y}_{q} [ k + n ]\end{matrix} ) = \frac{1}{\sqrt{2 \cdot ( 1 + {m}^{2} )}} ( \begin{matrix}m & 1 \\ 1 & - m\end{matrix} ) ( \begin{matrix}{x}^{′} [ k ] + j \cdot k [ k + n ] \\ {x}^{′} [ k + 1 ] + j \cdot k [ k + n + 1 ]\end{matrix} ) \qquad ( 9 )$$

If the above Equation (9) is solved for x′[k], x′[k+1], x′[k+n] and x′[k+n+1], the following Equations (10), (11), (12) and (13) are obtained, respectively.

$$\begin{matrix}{x}^{′} ( k ) = \sqrt{\frac{2}{1 + {m}^{2}}} ( m \cdot {y}_{i} [ k ] + {y}_{i} [ k + n ] ) & ( 10 ) \\ {x}^{′} ( k + 1 ) = \sqrt{\frac{2}{1 + {m}^{2}}} ( {y}_{i} [ k ] - m \cdot {y}_{i} [ k + n ] ) & ( 11 ) \\ {x}^{′} ( k + 1 ) = \sqrt{\frac{2}{1 + {m}^{2}}} ( m \cdot {y}_{q} [ k ] + {y}_{q} [ k + n ] ) & ( 12 ) \\ {x}^{′} ( k + n + 1 ) = \sqrt{\frac{2}{1 + {m}^{2}}} ( {y}_{q} [ k ] - m \cdot {y}_{q} [ k + n ] ) & ( 13 )\end{matrix}$$

Here, the sign of each coefficient is positive, so that the sign (i.e. whether it is positive or negative) of x′[k], x′[k+1], x′[k+n] and x′[k+n+1] is determined by the sign of those other than these coefficients. Thus, if the calculation of those other than the coefficients shown in the above Equations is done in the receiving side, it can be estimated that the transmission bit is either +1 or −1.

A specific description will now be given. The respective signal points assigned at the first and the second transmission are expressed by the following Equations (14) and (15) using Equation (9). In Equations (14) and (15), α is (1/SQRT(2(1+m²))), where SQRT(Y) is a function that computes the square root of Y. Equation (14) indicates a received symbol corresponding to a first-half preamble, whereas Equation (15) indicates a received symbol corresponding to a second-half preamble.
A+jB=α·((x[k]+j·x[k+n])+2·(x[k+1]+j·x[k+n+1])) (14)
C+jD=α·(2(x[k]+j·x[k+n])−(x[k+1]+j·x[k+n+1])) (15)

As a result, A, B, C and D are expressed by the following Equations (16) to (19), respectively, using Equations (14) and (15).
A=α·(x[k]+2·x[k+1]) (16)
B=α·(x[k+n]+2·x[k+n+1]) (17)
C=α·(2·x[k]−x[k+1]) (18)
D=α·(2·x[k+n]−x[k+n+1]) (19)

Here α>0. What will be finally derived in each of the computing units 40 is the signs of A, B, C and D. Hence, α may be ignored. Accordingly, if Equations (16) to (19) are solved for x[k], x[k+1], x[k+n] and x[k+n+1], respectively, the following decision equations (20) to (23) will be derived.
x[k]: A+2C (20)
x[k+1]: 2A−C (21)
x[k+n]: B+2D (22)
x[k+n+1]: 2B−D (23)

Equations (20) to (23) represent computing equations by which to derive the first combined symbols in the first computing unit 42 to the fourth computing unit 48, respectively, wherein the first combined symbol will be hereinafter denoted by x1[*] in the equations. The first computing unit 42 to the fourth computing unit 48 derive not only the first combined symbol but also the second combined symbol (hereinafter denoted by x2[*] in the equations) and the third combined symbol (hereinafter denoted by x3[*] in the equations), so that each component is multiplied by the weighting factor. Here, if the weighting factor is ½, the first computing unit 42 will derive a first to a third symbol using the following Equations (24) to (26), respectively.
x1[k]: A+2C (24)
x2[k]: A/2+2C (25)
x3[k]: A+2C/2=A+C (26)

In other words, Equation (24) indicates that if the signal strength of a preamble is greater than or equal to the threshold value, C which seems to have a higher signal energy will be multiplied by 2 so as to be combined with A and therefore it is likely that a correct result can be obtained thereby. As for Equation (25), if the signal strength of a preamble is less than the threshold value and if the signal strength of a preamble for the first transmission is smaller, it will be most probable that the reliability of A for the first received symbol is also smaller. Therefore Equation (25) indicates that multiplying A by ½ and combining it with C facilitates obtaining a correct result.

As for Equation (26), if the signal strength of a preamble is less than the threshold value and if the signal strength of a preamble for the second transmission is smaller, it will be most probable that the reliability of C for the second received symbol is also smaller. Therefore Equation (26) indicates that multiplying 2C (C times 2) by ½ and combining it with A facilitates obtaining a correct result.

Due to the frequency selective fading, there are cases where the signal strength of a preamble at one transmission are significantly deteriorated as compared with that at the other transmission. By employing the structure as in the above-described embodiment, the effect of frequency selective fading can be reduced and therefore the receiving performance can be enhanced.

Similarly, if the weighting factor is set to ½, the second computing unit 44 will derive a first to a third combined symbol using the following Equations (27) to (29), respectively.
x1[k+1]: 2A−C (27)
x2[k+1]: 2A/2−C=A−C (28)
x3[k+1]: 2A−C/2 (29)

Similarly, if the weighting factor is set to ½, the third computing unit 46 will derive a first to a third combined symbol using the following Equations (30) to (32), respectively.
x1[k+n]: B+2D (30)
x2[k+n]: B/2+2D (31)
x3[k+n]: B+2D/2=B+D (32)

Similarly, if the weighting factor is set to ½, the third computing unit 46 will derive a first to a third combined symbol using the following Equations (33) to (35), respectively.
x1[k+n+1]: 2B−D (33)
x2[k+n+1]: 2B/2−D=B−D (34)
x3[k+n+1]: 2B−D/2 (35)

For simplicity of explanation, a description will be given hereinbelow of the first combined symbols only, among the combined symbols derived respectively by the first computing unit 42 to the fourth computing unit 48.

Next, the computing unit 40 converts a soft-decision value to a hard-decision value. In a hard decision here, it is only necessary to perform the opposite of sign conversion done at the transmission side, namely it is preferable that if the signal is positive, it will be converted to 1 whereas if the sign is negative, it will be converted to 0. A description will now be given using examples. For instance, suppose that the following bit sequence is transmitted in the transmitting apparatus shown in FIG. 1.
{x[k], x[k+1], x[k+n], x[k+n+1]}={0, 1, 0, 1} (36)

Further, suppose that {1.6, 1.7} is received as the first received data coordinate and {−1.4, −1.4} is received as the second received data coordinate in the receiving apparatus 12. Then, x[k], x[k+1], x[k+n] and x[k+n+1] will be derived as follows if Equation (24), Equation (27) and Equation (30) are used. In this case, the bit sequence after the hard decision is equal to the bit sequence (0 1 0 1) transmitted.
x[k]: A+2C=1.6−2.8=−1.2→0 (37)
x[k+1]: 2A−C=3.2+1.4=+4.6→1 (38)
x[k+n]: B+2D=1.7−2.8=−1.1→0 (39)
x[k+n+1]: 2B−D=3.4+1.4=+5.8→1 (40)

Here, while {1.6, 1.7} is still used as the first received data coordinate, the second received data coordinate will be examined in the case when no error occurs. Here, the following conditional equations (41) to (44) will be derived if Equation (24), Equation (27), Equation (30) and Equation (33) are used.
x[k]: A+2C=1.6−2C<0→C<−0.8 (41)
x[k+1]: 2A−C=3.2−C≧0→C≦+3.2 (42)
x[k+n]: B+2D=1.7+2D<0→D<−0.85 (43)
x[k+n+1]:2B−D=3.4−D≧0→D≦+3.4 (44)

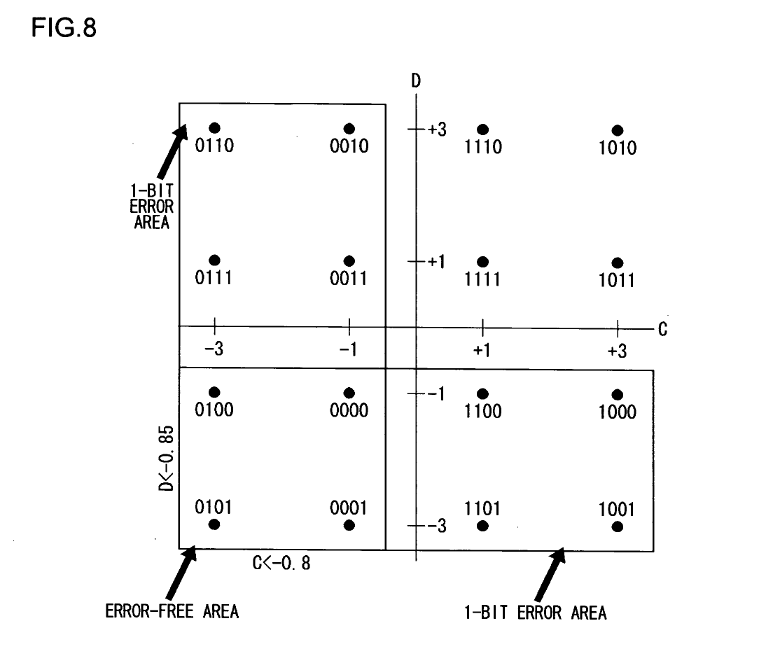

Therefore, error is eliminated if C<−0.8 and D<−0.85. Also, if C<−0.8 or D<−0.85, then error will be in the margin of 1 bit only. In this manner, the high degree of stability is achieved over the wide range. Such a high degree of stability can be secured because the coefficient m and the sign in the decision equations are so operated as to derive the correct decision values. FIG. 8 shows an example of symbol areas to be received under the above conditions.

In the example of the above Equation (36), it is desired that the result of the computing for the first bit (0) in the first transmission be of a negative value. In other words, if the weighting of bits in the second transmission, in which larger values are obtained coordinates-wise, is set to a large value, it is highly probable that the result of computation is of a negative value. On the other hand, it is desired that the result of computing for the second bit (1) in the first transmission be of a positive value.

In principle, if the weighting of Equation (1) concerning the first transmission which is of a positive value is set to a larger value and a soft-decision value received at the second transmission which is of a negative value is subtracted, the probability that the result of computation is of a positive value can be raised. That is, if a symbol assigned to a signal point whose distance from the origin is far is multiplied by a larger weighting factor, the energy of received symbols can be increased efficiently and therefore the error rate can be significantly reduced.

In Equation (2), m₁ and m₂ are each set twice as much as m₀, and the sign of m₃ is the reverse of the sign of m₀, so that at the first transmission the weighting is performed on the quadrature components and at the second transmission the weighting is performed on the in-phase components. Thereby, the distance between signals to be assigned at the first time and the second time are set far, so that error resilience is averaged.

The sign of m₀ is the reverse of the sign of m₃, so that the quadrants of signal points to be assigned at the first time and the second time can be made to differ from each other. With such an operation, the assignment of symbols differs for each transmission and the symbols are therefore assigned to the signal points having different error resiliences. Thereby, the error resilience is further averaged and the error rate is reduced.

Referring to FIGS. 4C and 4D, the operation and effects of the determination unit 50 will be explained. When sixteen signal points indicated in FIGS. 4C and 4D are thought of as a matrix, the four signals contained in the first column of FIG. 4C are the same as those contained in the second column of FIG. 4D.

Since at the transmission side the first bit of each signal point, namely x[k], is 0, it is required that (A+2C)<0 holds according to Equation (24) in order to be correctly determined at the receiving side. Here, by Equation (16) and Equation (18) A is larger than C. That is, if A is considered a reference, C<(−A/2). And if C satisfies this condition, a correct determination result will be obtained in the receiving side.

If the signal strength of a preamble is less than or equal to a threshold value, x[k] will be derived using Equation (25) or Equation (26). As for Equation (25), namely in the case where the signal strength of a preamble at the first transmission is larger than that at the second transmission, it is necessary that the condition of C<(−A) be met in order to obtain a correct determination result if treated the same way as above.

In other words, one on which the weighting is performed is selected by the determination unit 50, so that the range of C to obtain a correct determination result is broadened as compared with the above case and therefore the receiving characteristics are enhanced. It goes without saying that this holds true for other rows and columns.

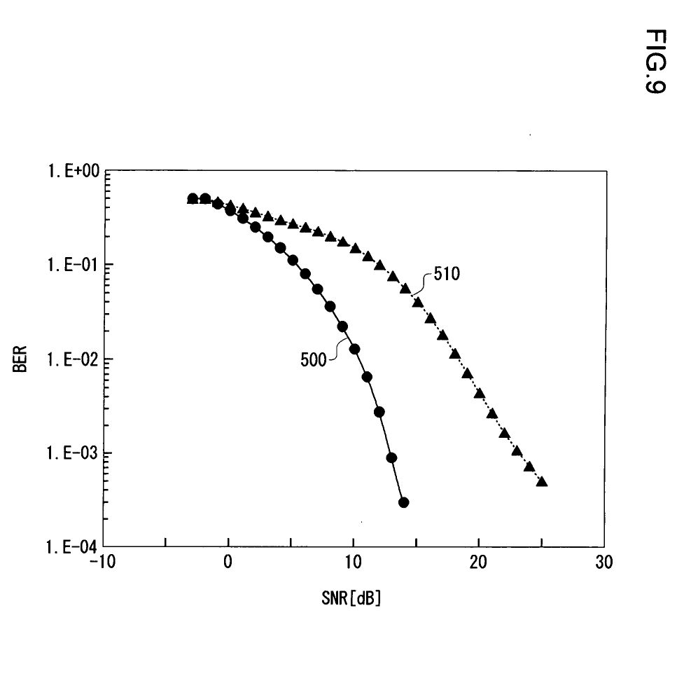

FIG. 9 demonstrates a performance example of the demodulation execution unit 74 shown in FIG. 5. The horizontal axis indicates an SNR (Signal-to-Noise Ratio). The vertical axis indicates a BER (Bit Error Rate). In the vertical axis, 1.E−01 indicates 10 raised to the power of (−1), namely 0.1.

In FIG. 9, BER characteristics 510 indicated by the dotted line show the characteristics in a conventional method. BER characteristics 500 indicated by the solid line show the characteristics obtained when an embodiment of the present invention is employed. In FIG. 9, the difference between these two at the point when BER is 1.E(−02) is 7.5 dB, and it is evident from this that the error rate can be reduced significantly by employing the present embodiment.

In the case when the SNR is 5 dB or below, there is not much difference in between the BER characteristics 500 of the conventional method and the BER characteristics 510 of the present embodiment. Thus, as described above, in the case where the SNR is used as the threshold value, it is preferred that the single symbol demodulation is done if the SNR is 5 dB or below and the symbol combining demodulation is done if the SNR is above 5 dB. Also, if the threshold value is set to a value larger than 5 dB, e.g., 10 dB, the emphasis can be placed on the power consumption rather than the error rate. In other words, setting the threshold value variably allows a flexible processing.

In terms of hardware, the above-described structure can be realized by a CPU, a memory and other LSIs of an arbitrary computer. In terms of software, it can be realized by memory-loaded programs or the like, but drawn and described here are function blocks that are realized in cooperation with those. Thus, it is understood by those skilled in the art that these function blocks can be realized in a variety of forms by hardware only, software only, or the combination thereof.

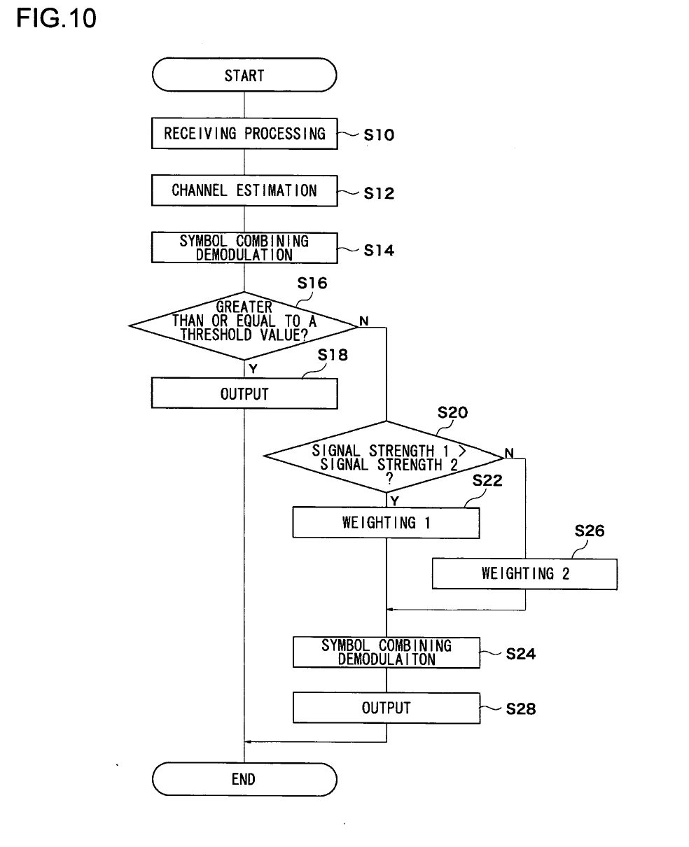

FIG. 10 is a flowchart showing an example of an operation of the baseband demodulation unit 34 shown in FIG. 5. Firstly, the FFT unit 70 performs a receiving processing, such as FFT processing, on the received signals (S10). Then, the channel estimation is performed on a plurality of preamble signals, respectively, so as to derive a plurality of channel estimation values (S12).

Then, for the first and the second symbol the computing unit 40 derives three combined symbols for each symbol (S14). Here, if the signal strength of both preamble signals is greater than or equal to a threshold value (Y of S16), the determination unit 50 will output the first combined symbol derived using Equation (24), for example, and terminate the operation. If at least one of the preamble signals is less than the threshold value (N of S16), proceed to Step S20.

In Step S20, the signal strengths of two preambles are compared. If the signal strength of the first preamble is greater (Y of S20), the weighting 1 will be performed (S22) and then the symbol combining will be performed so as to derive the second combined symbol (S24). The weighting 1 is, for example, such that C is multiplied by the weighting factor ½ in Equation (26).

If, on the other hand, the strength of the first preamble is smaller (N of S20), the weighting 2 will be performed (S26) and then the symbol combining will be performed so as to derive the third combined symbol (S24). The weighting 2 is, for example, such that A is multiplied by the weighting factor ½ in Equation (25). After the symbol combining in Step S24, the derived combined symbol is outputted (S28) to terminate the processing.

Next, modifications to the embodiments of the present invention will be described. The present modification has a structure similar to the communication system 100 shown in FIG. 1. The baseband demodulation unit 34 in the communication system 100 has a structure shown in FIG. 5, for example.

In this modification, as compared with the above embodiments, m₀ to m₃ each takes a different value in Equation (1) and Equation (2) given in the modulation processing method adopted in the baseband modulation unit 14 shown in FIG. 1. Note here that the portions common to the above-described embodiments are given the same reference numerals to simplify the explanation thereof.

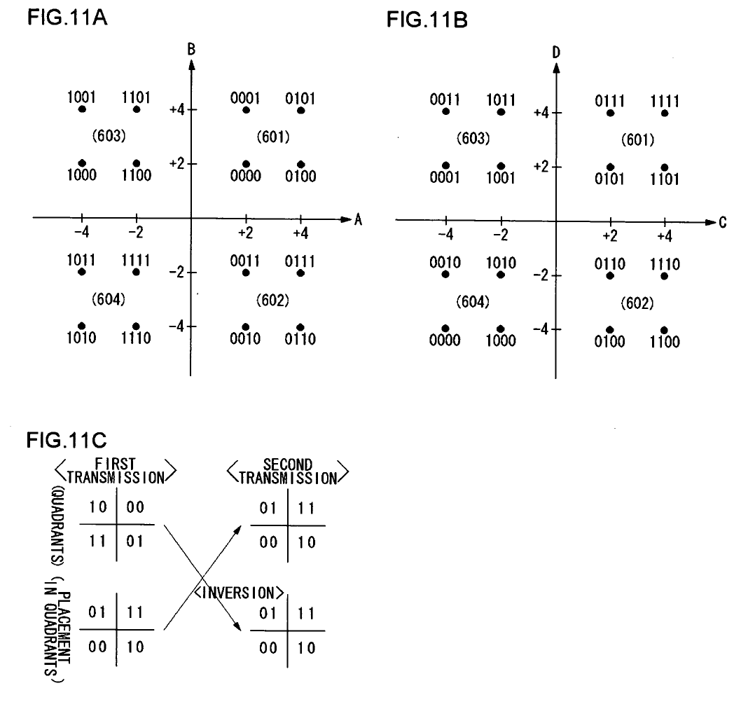

FIGS. 11A to 11C are a modification over FIGS. 4C to 4E. FIG. 11A shows a signal constellation for the first transmission in the modulation processing of the transmitting apparatus 10 shown in FIG. 1. FIG. 11B shows a signal constellation for the second transmission in the modulation processing of the transmitting apparatus 10 shown in FIG. 1. A description will be given here of a relationship between the first signal constellation shown in FIG. 11A and the second signal constellation shown in FIG. 11B.

Firstly, each bit contained in the bit sequence to be transmitted is converted to a signed code. Here, if the four bits of a transmitting signal after the conversion are denoted by x[k], x[k+1], x[k+n], and x[k+n+1], then the two signal constellations d[k] and d[k+n] will be expressed by Equations (1) and (2). Assume here that m₀=(−m₃)=−3 and m₁=m₂=1.

From a different point of view, a description is given here of a relation between the first signal point constellation shown in FIG. 11A and the second signal point constellation shown in FIG. 11B. The relation between the bits indicative of the quadrants concerning the signal constellations shown in FIG. 11A and FIG. 11B, respectively, and the bits indicative of the positions within the quadrants is shown in FIG. 11C. That is, the relation of the signal constellation in the second transmission to that in the first transmission is such that the bits indicating the quadrants and those indicating the assignment positions within the quadrants in the first transmission are switched around.

The relationship shown in FIG. 11C is as follows. In Equation (1) and Equation (2), m₀ is three times as much m₁ or m₂, and the sign of m₃ is the reverse of m₀. Thereby, the weighting is performed on the quadrature components at the first transmission, whereas the weighting is performed on the in-phase components at the second transmission.

As a result thereof, similar to the above-described embodiments, the distances of the signal points to be assigned in the first and the second transmission are set far and hence the error resilience is averaged. Since the sign of m₃ is set to the opposite sign of m₀ and vice versa, the quadrants on which the signal points are to be assigned can be made to differ at the first and the second transmission.

Another modification to the present embodiments will now be described. This modification has a structure similar to the communication system 100 shown in FIG. 1. The baseband demodulation unit 34 in the communication system 100 has a structure shown in FIG. 5, for example. In this modification, as compared with the above embodiments, m₀ to m₃ each takes a different value in Equation (2) given in the modulation processing method adopted in the baseband modulation unit 14 shown in FIG. 1. Note here that the portions common to the above-described embodiments are given the same reference numerals to simplify the explanation thereof.

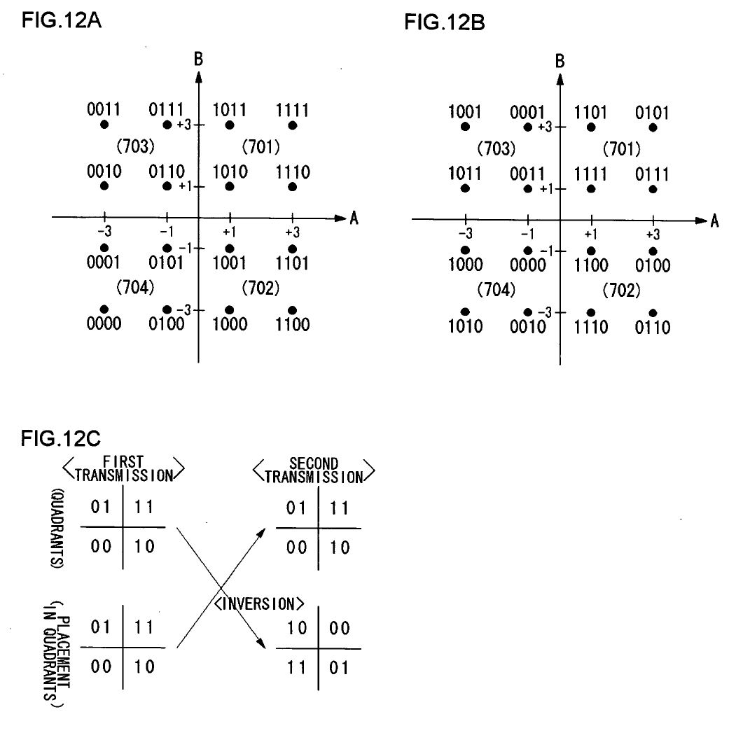

FIGS. 12A to 12C are another modification over FIGS. 4C to 4E. FIG. 12A shows a signal constellation for the first transmission in the modulation processing of the transmitting apparatus 10 shown in FIG. 1. FIG. 12B shows a signal constellation for the second transmission in the modulation processing of the transmitting apparatus 10 shown in FIG. 1. A description will be given here of a relationship between the first signal constellation shown in FIG. 12A and the second signal constellation shown in FIG. 12B. Firstly, each bit contained in the bit sequence to be transmitted is converted to a signed code.

Here, the four bits of a transmitting signal after the conversion are denoted by x[k], x[k+1], x[k+n], and x[k+n+1], then the two signal constellations d[k] and d[k+n] will be expressed by Equations (1) and (2). Assume here that m₀=m₃=2 and m₁=(−m₂)=1.

From a different point of view, a description is given here of a relation between the first signal point constellation shown in FIG. 12A and the second signal point constellation shown in FIG. 12B. The relation between the bits indicative of the quadrants concerning the signal constellations shown in FIG. 12A and FIG. 12B, respectively, and the bits indicative of the positions within the quadrants is shown in FIG. 12C. That is, the relation of the signal constellation in the second transmission to that in the first transmission is such that the bits indicating the quadrants and those indicating the assignment positions within the quadrants in the first transmission are switched around.

The relationship shown in FIG. 12C is as follows. In Equation (1) and Equation (2), m₀ and m₃ is each twice as much m₁, and the sign of m₂ is the reverse of m₁. Thereby, the weighting is performed on the quadrature components at the first transmission, whereas the weighting is performed on the in-phase components at the second transmission.

As a result thereof, similar to the above-described embodiments or embodiment, the distances of the signal points to be assigned in the first and the second transmission are set far and hence the error resilience is averaged. Since the sign of m₂ is set to the opposite sign of m₁ and vice versa, the quadrants on which the signal points are to be assigned can be made to differ at the first and the second transmission.

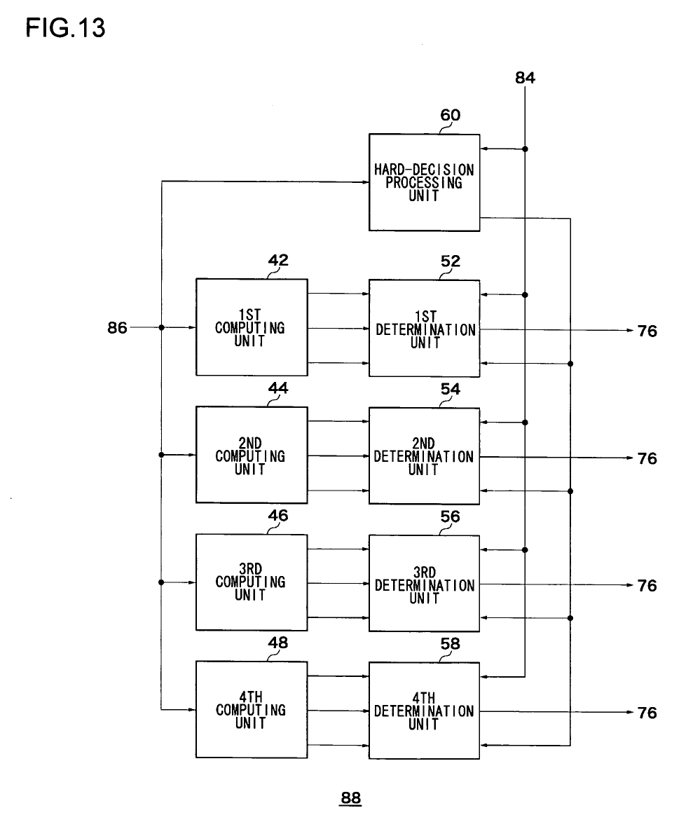

Still another modification to the present embodiments will now be described. This modification has a structure similar to the communication system 100 shown in FIG. 1. The baseband demodulation unit 34 in the communication system 100 has a structure shown in FIG. 5, for example. In this modification, as compared with the above embodiment, the symbol demodulation unit 88 is configured as shown in FIG. 13 instead of FIG. 7. Note here that the portions common to the above-described embodiments are given the same reference numerals to simplify the explanation thereof.

FIG. 13 illustrates a modification to the symbol demodulation unit 88 shown in FIG. 7. The structure of a symbol demodulation unit 88 according to this modification is such that a hard-decision processing unit 60 is added to the structure shown in FIG. 7. Of the symbols received by the symbol receiver 86, the hard-decision processing unit 60 performs hard-decision processing on each symbol having the larger signal strength of each corresponding preamble and then outputs four hard-decision values. As described above, the computing unit 40 derives the combined symbols.

The determination unit 50 compares the hard-decision value outputted by the hard-decision processing unit 60, with the hard-decision value of the first combined symbol among the combined symbols derived by the computing unit 40. When both values agree, the degree of reliability for the first combined symbol is said to be high, so that the first combined symbol is outputted without change. When, on the other hand, they do not agree, the second combined symbol, which has been combined after the weighting corresponding to the signal strength of each corresponding preamble has been performed on the corresponding symbol, or the third combined symbol is outputted as described above.

By employing the above embodiments, the error resiliences are made to differ and therefore the error rate in the receiving side can be reduced averagely. The bit assignment within each symbol in the QAM modulation and the arrangement rule for signal points are varied per transmission. This can prevent any particular symbol from constantly exhibiting the low error resilience and therefore the error can be reduced and the throughput can be enhanced. For example, the signal points assigned at the first and the second transmission are located across the origin and may be assigned in a manner that the distance between the signal points gets far. Thereby, the symbols assigned to the signal points located closer to the origin in the first transmission are assigned to the signal points located far away from the origin in the second transmission. As a result, the error resilience is averaged and the error rate as a whole can be reduced.

Also, by employing the simplified processing as described above, the same symbols can be assigned to the different signal points without the increase in circuit scale. The same symbols assigned respectively to different signal points are combined in consideration of their respective correspondences, so that the energy at the time of the receiving can be increased. Thereby, the error rate can be reduced. If a symbol assigned to a signal point whose distance from the origin is far is multiplied by a larger weighting factor, the energy of received symbols can be increased efficiently and therefore the error rate can be significantly reduced. Since the error rate is reduced, the number of retransmissions can be reduced, thereby enhancing the throughput.

If the propagation channel is in a good condition, a single symbol only is to be demodulated, so that the processing amount and the power consumption can be reduced. If the SNR serves as a threshold value, then a single symbol demodulation will be performed when it is less than or equal to 5 dB and the symbol combining demodulation will be performed when it is greater than 5 dB, for example. If the threshold value is set to the value greater than 5 dB, e.g., about 10 dB, then emphasis can be placed on the processing amount or power consumption rather than the error rate. In other words, setting the threshold allows the flexible processing.

By employing the embodiments described as above, the same symbols assigned respectively to the different signal points are combined by switching the weighting methods, based on the signal strength of preambles, in the consideration of their respective correspondences. As a result, the energy at the time of the receiving can be increased and the receiving performance such as error rate can be improved.

The symbols are combined by changing the order of bits, so that the symbols to be handled can be demodulated efficiently without the increase in circuit scale. A symbol, assigned to a signal point whose distance from the origin is far, is multiplied by a larger weighing factor than that for the other symbols. Thus, the energy for symbols having the higher degree of reliability can be increased and therefore the receiving characteristics can be enhanced.

The present invention has been described based on the embodiments. These embodiments and modifications are merely exemplary, and it is understood by those skilled in the art that various other modifications to the combination of each component and process thereof are possible and that such modifications are also within the scope of the present invention.

In the embodiments of the present invention, the OFDM communications in the UWB scheme have been mentioned. However, the prevent invention is not limited thereto and may be applied to other communication schemes, such as TDMA, FDMA, CDMA or any combination thereof.

In the embodiments of the present invention, 16-QAM has been mentioned. However, the present invention is not limited thereto and may be applied to other multi-level modulation schemes such as 32-QAM in which the distances from the origin are different, respectively, or modulation schemes such as 8A-PSK. In such cases, too, the positions of signal points to which symbols are to be assigned may be varied so that the error resiliences thereof are made to differ.

A description has been given of a case where three combined symbols are derived in the computing unit 40 shown in FIG. 7 according to an embodiment as well as shown in FIG. 13 according to a modification of the present invention. However, this should not be considered as limiting, and the computing unit 40 may first derive the first combined symbol only. In such a case, if the signal strength of a preamble is less than a threshold value or if the hard-decision value of symbols and the hard-decision value of the first combined symbol do not agree, the determination unit 50 may have the computing unit 40 derive the second combined symbol or the third combined symbol according to the signal strength of two preambles. In this case, the same advantageous effects can be maintained and the computational amount can be reduced and therefore the power consumption can be reduced.

While the preferred embodiments of the present invention have been described using specific terms, such description is for illustrative purposes only, and it is to be understood that changes and variations may be made without departing from the spirit or scope of the appended claims.

What is claimed is:

1. A receiving apparatus, comprising:
a symbol receiver which receives a first symbol assigned to a point of a plurality of signal points contained in a signal constellation, using a modulation scheme based on the signal constellation that contains a plurality of signal points having a plurality of kinds of amplitudes, and a second symbol which is the same symbol as the first symbol modulated using the modulation scheme but assigned to another signal point; and
a symbol demodulation unit which demodulates symbols to be demodulated, in a manner such that signal points of the symbols received by said symbol receiver are combined by mutual correspondence between the first symbols and the second symbols, respectively.

2. A receiving apparatus according to claim 1, further comprising:
a measurement unit which measures the signal strength of the first symbol and the second symbols; and
a selector which selects a larger signal strength among a plurality of signal strengths measured by said measurement,
wherein when the signal strength selected by said selector is greater than a threshold value for the signal strength, said symbol demodulation unit demodulates a symbol corresponding to said signal strength and wherein when the signal strength selected by said selector is less than or equal to the threshold value, said symbol demodulation unit demodulates the symbols to be demodulated in a manner such that the signal points of the symbols received by said symbol receiver are combined by mutual correspondence among the signal points of the symbols, respectively.

3. A receiving apparatus according to claim 1, wherein said demodulation unit combines the symbols assigned to the respective signal points by varying the order of bits indicating quadrants of the respective signals to which the symbols have been assigned and the order of bits indicating placement within the quadrants.

4. A receiving apparatus according to claim 1, wherein said symbol demodulation unit multiplies, per symbol, either one of an in-phase component and a quadrature component by a weighting factor, for a plurality of bits contained in each symbol and then combines the symbols assigned to the respective signal points.

5. A receiving apparatus according to claim 1, wherein, among a plurality of symbols, said symbol demodulation unit multiplies a symbol, assigned to a signal point whose distance from the origin is far, by a larger weighting factor than those for the other symbols, and then combines the symbols.

6. A demodulation method, including:
receiving a first symbol, assigned to a point of a plurality of signal points contained in a signal constellation, by using a modulation scheme based on the signal constellation that contains a plurality of signal points having a plurality of kinds of amplitudes and a second symbol which is the same symbol as the first symbol modulated by using the modulation scheme but assigned to another signal point; and
demodulating symbols to be demodulated, in a manner such that signal points of the symbols received in said receiving are combined by mutual correspondence between the first symbols and the second symbols, respectively.

7. A demodulation apparatus, comprising:
a symbol receiver which receives a first symbol assigned to a point of a plurality of signal points contained in a signal constellation, using a modulation scheme based on the signal constellation that contains a plurality of signal points having a plurality of kinds of amplitudes, and a second symbol which is the same symbol as the first symbol modulated using the modulation scheme but assigned to another signal point;
a preamble receiver which receives preambles corresponding respectively to the first symbol and the second symbol received by said symbol receiver;
a signal-strength measurement unit which measures the signal strength of the first symbol and the second symbol received by said preamble receiver; and
a symbol demodulation unit which demodulates the first symbol and the second symbol received by said symbol receiver, based on the signal strength of the respective preambles measured by said signal-strength measurement unit,
wherein when the degree of reliability of a symbol which has been demodulated in a manner such that the signal points of the symbols received by said symbol receiver are combined by mutual correspondence among the signal points of the symbols, respectively, is greater than or equal to a predetermined threshold value, said symbol demodulation unit outputs the symbol and wherein when the degree of reliability of a symbol which has been demodulated in a manner such that the signal points of the symbols received by said symbol receiver are combined by mutual correspondence among the signal points of the symbols, respectively, is less than the predetermined threshold value, said demodulation unit performs weightings corresponding to the degrees of reliability for the respective preambles measured by said signal-strength measurement unit on symbols corresponding respectively to the preambles and outputs the symbols which have been demodulated in a manner such that the signal points of the weighted symbols are combined by mutual correspondence among the signal points of the weighted symbols.

8. A demodulation apparatus, comprising:
a symbol receiver which receives a first symbol assigned to a point of a plurality of signal points contained in a signal constellation, using a modulation scheme based on the signal constellation that contains a plurality of signal points having a plurality of kinds of amplitudes, and a second symbol which is the same symbol as the first symbol modulated using the modulation scheme but assigned to another signal point;
a preamble receiver which receives preambles corresponding respectively to the first symbol and the second symbol received by said symbol receiver;
a signal-strength measurement unit which measures the signal strength of the first symbol and the second symbol received by said preamble receiver;
a symbol demodulation unit which demodulates symbols the first symbol and the second symbol received by said symbol receiver, based on the signal strength of the respective preambles measured by said signal-strength measurement unit; and
a hard-decision unit which performs hard-decision processing on either the first symbol or the second symbol, received by said symbol receiver, whichever is larger in the signal strength and outputs a hard-decision value,
wherein when the hard-decision value outputted from said hard-decision unit agrees with that of a symbol demodulated in a manner such that the signal points of the symbols received by said symbol receiver are combined by mutual correspondence among the signal points of the symbols, respectively, said symbol demodulation unit outputs the symbol, and wherein when the hard-decision value outputted from said hard-decision unit differs from that of a symbol demodulated in a manner such that the signal points of the symbols received by said symbol receiver are combined by mutual correspondence among the signal points of the symbols, respectively, said demodulation unit performs weightings corresponding to the signal strength of the respective preambles measured by said signal-strength measurement unit on symbols corresponding respectively to the preambles and outputs the symbols which have been demodulated in a manner such that the signal points of the weighted symbols are combined by mutual correspondence among the signal points of the weighted symbols.

9. A demodulation apparatus according to claim 7, wherein said symbol demodulation unit combines the symbols assigned to the respective signals by varying the order of bits indicating quadrants of the respective signals to which the symbols have been assigned and the order of bits indicating placement within the quadrants.

10. A demodulation apparatus according to claim 8, wherein said symbol demodulation unit combines the symbols assigned to the respective signals by varying the order of bits indicating quadrants of the respective signals to which the symbols have been assigned and the order of bits indicating placement within the quadrants.

11. A demodulation apparatus according to claim 7, wherein, among a plurality of symbols received by said symbol receiver, said symbol demodulation unit multiplies a symbol, assigned to a signal point whose distance from the origin is far, by a larger weighting factor than those for the other symbols, and then combines the symbols.

12. A demodulation apparatus according to claim 8, wherein, among a plurality of symbols received by said symbol receiver, said symbol demodulation unit multiplies a symbol, assigned to a signal point whose distance from the origin is far, by a larger weighting factor than those for the other symbols, and then combines the symbols.

13. A demodulation method, including:
receiving a first symbol assigned to a point of a plurality of signal points contained in a signal constellation, by using a modulation scheme based on the signal constellation that contains a plurality of signal points having a plurality of kinds of amplitudes, and a second symbol which is the same symbol as the first symbol modulated by using the modulation scheme but assigned to another signal point;
measuring the signal strength of preambles corresponding respectively to the first symbol and the second symbol; and
demodulating the first symbol and the second symbol, either in a manner such that signal points of the received symbols are combined by mutual correspondence between the first symbols and the second symbols, respectively, or in a manner such that weightings corresponding to the signal strength of the respective preambles measured by said measuring are performed on symbols corresponding respectively to the preambles and then the signal points of the weighted symbols are combined by mutual correspondence among the signal points of the weighted symbols.
